(19) United States
(12) Patent Application Publication
(10) Pub. No.: US 2011/0190056 A1
(43) Pub. Date: Aug. 4, 2011

(54) Motion-Sensing Controller, Related Apparatus and Methods

(76) Inventors: Qiang Xu, San Diego, CA (US); Michelle Liu Shu, Saratoga, CA (US)

(21) Appl. No.: 12/697,128

(22) Filed: Jan. 29, 2010

(51) Int. Cl. A63F 9/24; G06F 3/02

(52) U.S. Cl. 463/36; 345/169

(57) ABSTRACT

Improved motion-sensing controllers of the invention comprise: a base that allows the motion-sensing controller to transmit any necessary signals remotely; at least one primary button configured for continual actuation of the motion-sensing controller upon being pressed and released; and, optionally, at least one auxiliary button. A motion-sensing controller apparatus of the invention comprises: a case for insertion of a motion-sensing controller therein; at least one retainer capable of securing the motion-sensing controller in the case; optionally, at least one retainer button coupled to the retainer for mechanically facilitating continual and/or momentary actuation of the motion-sensing controller; optionally, at least one connector mechanically coupled to the case for attaching the case to at least one piece of simulated sports, recreation, or similar equipment or portion thereof; and, optionally, at least one retaining clip mechanically coupled to the case for attaching the apparatus to at least one piece of actual sports, recreation, or similar equipment. Various embodiments of apparatus of the invention comprise different combinations and details of such components. Assemblies of the invention comprise such apparatus attached to at least one piece of actual or simulated sports, recreation, or similar equipment or portion thereof. Methods of using controllers and assemblies of the invention to play video games are also disclosed.

### BACKGROUND OF THE INVENTION

The present invention pertains to motion-sensing controllers, related apparatus and methods.

A variety of motion-sensing controllers, such as video game controllers, are known, particularly the “Wii Remote” motion-sensing video game console controller marketed by the Nintendo Corporation, Ltd. Motion-sensing video game controllers often provide a more fun and realistic game playing experience as compared to video game controllers that do not sense motion. A typical motion-sensing video game controller requires that a player hold and manipulate a motion-sensing controller continuously, while simultaneously actuating the controller by pressing and holding buttons on the controller during game play. The required pressing and holding of buttons can not only make game play less realistic, however, but it can also lead to discomfort, strain, and in some cases pain, in a player's hand and/or body.

Despite popularity of motion-sensing video game controllers, present apparatus that couple with such controllers often do not replicate realistic grip skills and body positions during game play. While a “Wii Wheel” accessory for the “Wii Remote” motion-sensing video game controller is also marketed by the Nintendo Corporation, Ltd. and provides a somewhat realistic simulated driving game playing experience, the “Wii Wheel” disadvantageously requires that a player simultaneously actuate the controller by pressing and holding buttons on the controller during game play. The same disadvantage is associated with other known accessories for the “Wii Remote” motion-sensing video game controller. For example, the same holds true for the many accessories marketed by CTA Digital (Brooklyn, N.Y.), including the swordplay attachment, canoeing attachment, golf club attachment, table tennis attachment, frisbee attachment, wakeboarding attachment, archery bow attachment, power cruising dashboard handle marketed by CTA Digital as part of a “8 in 1 Pack for Wii Sports Resort.” Many of these accessories are described as attachments that are optionally used with a lightweight plastic attachable insert for securing a “Wii Remote” between the attachment and the attachable insert. Most of these accessories require that the “Wii Remote” be placed in the grip portion of the attachment, restricting design flexibility needed to provide realistic game play experiences. Such accessories also generally require that a player simultaneously actuate the controller (e.g., “Wii Remote”) by pressing and holding buttons on the controller during game play. In addition, such accessories often do not provide realistic game play experiences in that they provide only a portion of sports, recreation, or similar equipment whose use is simulated in the video game. For example, a “Wii Baseball Bat” marketed by the Nintendo Corporation, Ltd. does not provide a realistic handle for the “Wii Remote.” Further, although additional accessories are known for connection to the “Wii Remote” motion-sensing video game controller, such accessories generally do not include features necessary to mechanically facilitate continual and/or momentary actuation of the motion-sensing video game controller.

Improved methods and apparatus are desirable for motion-sensing controllers. Particularly desirable are methods and apparatus that allow a motion-sensing video game controller to be continuously actuated without requiring holding down of a button on the controller. Also desirable are apparatus that allow a player to use a motion-sensing video game controller while holding and gripping an apparatus shaped like an object displayed in a video game, e.g., sports, recreation, or similar equipment.

### SUMMARY OF THE INVENTION

An improved motion-sensing controller of the invention comprises: a base that allows the motion-sensing controller to transmit any necessary signals remotely; at least one primary button configured for continual actuation of the motion-sensing controller when pressed and continuing upon release of the primary button; and, optionally, at least one auxiliary button. In one embodiment, the base comprises a rectangular bar shape capable of being held in a player's hand.

According to one embodiment, the primary button is configured to momentarily actuate the motion-sensing controller when partially pressed. The motion-sensing controller is then de-actuated after release of such a partial press on the primary button. According to this embodiment, the primary button is also configured to continually actuate the motion-sensing controller when fully pressed and continuing upon release of the primary button. The motion-sensing controller is de-actuated after continual actuation thereof upon a further press and release of the primary button. The primary button is typically a button that is predominantly used for common game play.

In yet another embodiment, the primary button is shaped to resemble a switch. According to this embodiment, the primary button functions to continually actuate the motion-sensing controller when a first side of the primary button is pressed and continuing upon release of that first side of the primary button. According to a further aspect of this embodiment, when a second side of the primary button is pressed and released, the motion-sensing controller is de-actuated. Alternatively, when a second side of the primary button is pressed, the motion-sensing controller is momentarily actuated. The motion-sensing controller is then de-actuated after release of the second side of the primary button and/or upon a further press and release of the first side of the primary button.

In a still further embodiment, the motion-sensing controller comprises at least two primary buttons, wherein one or two primary buttons are configured so that the motion-sensing controller interprets pressing of the respective primary button as a command for continual actuation that continues upon release of that primary button. The motion-sensing controller is then de-actuated upon a further press and release of that primary button. According to an alternative embodiment, one or two primary buttons are configured so that the motion-sensing controller interprets pressing of the respective primary button as a command for momentary actuation. The motion-sensing controller is then de-actuated after release of that primary button.

In one embodiment, a motion-sensing controller apparatus of the invention comprises: a case for insertion of the motion-sensing controller therein; at least one retainer capable of securing the motion-sensing controller in the case, wherein the motion-sensing controller is secured between the at least one retainer and the case when the motion-sensing controller is inserted in the case; at least one retainer button coupled to the at least one retainer for mechanically facilitating continual and/or momentary actuation of the motion-sensing controller; optionally, at least one connector mechanically coupled to the case for attaching the case to at least one piece of simulated sports, recreation, or other similar equipment, or portion thereof; and, optionally, at least one retaining clip mechanically coupled to the case for attaching the apparatus to at least one piece of actual sports, recreation, or other similar equipment.

In another embodiment, a motion-sensing controller apparatus of the invention comprises: a case for insertion of the motion-sensing controller therein; at least one retainer capable of securing the motion-sensing controller in the case; at least one retainer button coupled to the at least one retainer for mechanically facilitating continual actuation of the motion-sensing controller; optionally, at least one connector mechanically coupled to the case for attaching the case to at least one piece of simulated sports, recreation, or other similar equipment, or portion thereof; and, optionally, at least one retaining clip mechanically coupled to the case for attaching the apparatus to at least one piece of actual sports, recreation, or other similar equipment.

In yet another embodiment, a motion-sensing controller apparatus of the invention comprises: a case for insertion of the motion-sensing controller therein; at least one retainer capable of securing the motion-sensing controller in the case; optionally, at least one retainer button coupled to the at least one retainer for mechanically facilitating continual and/or momentary actuation of the motion-sensing controller; at least one connector mechanically coupled to the case for attaching the case to a handle comprising a gripping portion of at least one piece of simulated sports, recreation, or other similar equipment; and, optionally, at least one retaining clip mechanically coupled to the case for attaching the apparatus to at least one piece of actual sport, recreation, or other similar equipment.

In still another embodiment, a motion-sensing controller apparatus of the invention comprises: a case for insertion of the motion-sensing controller therein; at least one retainer capable of securing the motion-sensing controller in the case; optionally, at least one retainer button coupled to the at least one retainer for mechanically facilitating continual and/or momentary actuation of the motion-sensing controller; optionally, at least one connector mechanically coupled to the case for attaching the case to at least one piece of simulated sports, recreation, or other similar equipment, or portion thereof; and, at least one retaining clip mechanically coupled to the case for attaching the apparatus to at least one piece of actual sports, recreation, or other similar equipment.

According to further embodiments of apparatus of the invention, the motion-sensing controller is secured housed the case. According to still further embodiments, the retainer is removably coupled to the case. In an exemplary embodiment, the retainer button functions to continually actuate the motion-sensing controller when a first side of the retainer button is pressed and continuing upon release of that first side of the retainer button.

Assemblies of the invention comprise such apparatus attached to at least one piece of actual or simulated sports, recreation, or similar equipment or a portion thereof. For example, such apparatus can be attached to a handle. In an exemplary embodiment, an apparatus of the invention is attached to a golf club, a tennis racket, a baseball bat, or a portion thereof.

Methods for video game play with a motion-sensing video game controller according to the invention comprise providing a motion-sensing video game controller or apparatus of the invention housing a motion-sensing video game controller and continually actuating the motion-sensing video game controller. In one embodiment, the motion-sensing video game controller is continually actuated using at least one retainer button on the apparatus.

### BRIEF DESCRIPTION OF THE SEVERAL VIEWS OF THE DRAWINGS

The present invention described herein will become apparent from the following detailed description considered in connection with the accompanying drawings, which disclose several embodiments of the invention. It should be understood, however, that the drawings are designed for the purpose of illustration and not as limits of the invention.

FIG. 1A is a top view of a motion-sensing controller according to the invention.

FIG. 1B is a side view of the motion-sensing controller of FIG. 1A.

FIG. 1C is a back view of the motion-sensing controller of FIGS. 1A and 1B.

FIG. 2 is a top view of another embodiment of a motion-sensing controller according to the invention.

FIG. 3 is a top view of another embodiment of a motion-sensing controller according to the invention.

FIG. 4A is a top perspective view of one embodiment of an apparatus for a motion-sensing controller according to the invention.

FIG. 4B is a bottom perspective view of another embodiment of an apparatus for a motion-sensing controller according to the invention.

FIG. 5 is a top perspective view of one embodiment of an apparatus housing a motion-sensing controller according to the invention.

FIG. 6 is a top perspective view of another embodiment of an apparatus housing a motion-sensing controller according to the invention.

FIG. 7 is a top perspective view of another embodiment of an apparatus housing a motion-sensing controller according to the invention.

FIG. 8 is a top perspective view of the apparatus of FIG. 4A attached to an exemplary handle for use with a motion-sensing controller housed in the apparatus according to the invention.

FIG. 9 is a top perspective view of the apparatus of FIG. 7 attached to an exemplary handle and an exemplary golf club head for use with a motion-sensing controller housed in the apparatus according to the invention.

FIG. 10 is a top perspective view of an apparatus of the invention attached to an exemplary handle and an exemplary portion of a baseball bat for use with a motion-sensing controller housed in the apparatus according to the invention.

FIG. 11 is a top perspective view of an apparatus of the invention attached to an exemplary handle and an exemplary portion of a racket for use with a motion-sensing controller housed in the apparatus according to the invention.

FIG. 12 is a side perspective view of the apparatus of FIG. 4B attached to an exemplary golf club and housing a motion-sensing controller according to the invention.

FIG. 13 is a side perspective view of an apparatus of the invention attached to an exemplary baseball bat and housing a motion-sensing controller according to the invention.

FIG. 14 is a top perspective view of an apparatus of the invention attached to an exemplary racket and housing a motion-sensing controller according to the invention.

FIG. 15 is a bottom perspective view of one embodiment of an apparatus comprising retaining clips according to the invention.

FIG. 16A is a bottom perspective view of another embodiment of an apparatus comprising a retaining clip according to the invention.

FIG. 16B is a bottom perspective view of the apparatus of FIG. 16A, wherein the retaining clip is secured to a portion of an exemplary handle.

FIG. 17 is a bottom perspective view of another embodiment of an apparatus comprising retaining clips according to the invention.

FIG. 18A is a bottom perspective view of yet another embodiment of an apparatus comprising retaining clips according to the invention.

FIG. 18B is a bottom perspective view of an alternate embodiment of the apparatus of FIG. 18A.

### DETAILED DESCRIPTION OF THE INVENTION

The present invention provides efficient and convenient methods and apparatus for control of motion-sensing equipment. Particularly disclosed are methods and apparatus for use with video games that employ motion-sensing controllers, including those that require moving the controller while pressing at least one button thereon to actuate the motion-sensing video game controller. Methods and apparatus of the invention are capable of being efficiently used with video games involving game play that simulates sports, recreation, or other movement. While the invention is described throughout with frequent reference to motion-sensing video game controllers, it is to be understood that the invention is equally applicable to motion-sensing equipment in general.

According to certain embodiments of the invention, methods and apparatus advantageously allow players to hold an apparatus shaped like an object displayed in a video game instead of merely holding a motion-sensing video game controller during game play. In one embodiment, apparatus of the invention are capable of attaching to at least one piece of actual sports, recreation, other similar equipment, or portion thereof for the purpose of providing more realistic simulation of game play or training using the equipment. In a related embodiment, apparatus of the invention are capable of attaching to at least one piece of simulated sports equipment, recreation equipment, other similar equipment, or portion thereof for the purpose of providing more realistic simulation of game play or training using the equipment. According to an exemplary embodiment, a player is able to hold an assembly shaped like an object displayed in a video game at a position on the assembly where one would normally grip the same as opposed to requiring that the assembly be held at the location of the motion-sensing controller therein.

According to an exemplary embodiment, an improved motion-sensing controller comprises: a base; at least one primary button; and, optionally, at least one auxiliary button. The at least one primary button is configured for continual actuation of the motion-sensing controller (e.g., actuation associated with at least one function during play of a video game using a motion-sensing video game controller of the invention) upon being pressed and released. While such continual actuation is facilitated by a single press (of any force and duration) and release in certain embodiments, alternative exemplary embodiments include those where such continual actuation is facilitated by pressing the at least one primary button for a minimum duration (e.g., two seconds) and then releasing the same and those where such continual actuation is facilitated by pressing and releasing the at least one primary button multiple times (e.g., two times) quickly in succession.

The base comprises any suitable shape and configuration that allows, and does not hinder ability of, the motion-sensing controller to transmit any necessary signals remotely. For example, in one embodiment, the base comprises a rectangular bar shape capable of being held in a player's hand. Such a base is used in a conventional “Wii Remote” motion-sensing video game controller marketed by Nintendo Corporation, Ltd.

A “primary button” as used herein is understood to be the button that is used a majority of the time during, for example, play of a video game. Improved primary buttons of the invention can be used as, for example, a substitute for the “A” and/or “B” buttons on a conventional “Wii Remote” motion-sensing video game controller marketed by Nintendo Corporation, Ltd. Depending on the video game, either the “A” or “B” button of a “Wii Remote” is considered the primary button for that application. Thus, a motion-sensing controller may be understood to have multiple primary buttons, one of which is the primary button for the particular application or game being controlled. A motion-sensing controller may also have multiple primary buttons, each of which could function as the primary button for a particular application or game being controlled, but which multiple primary buttons actuate the controller differently (e.g., by momentary or continual actuation of the controller) as discussed below in conjunction with certain embodiments of the invention.

Each of the primary buttons on motion-sensing controllers of the invention is located on any suitable part of the base and comprises any suitable shape and configuration for continual or momentary actuation of the motion-sensing controller. At least one primary button is configured for continual actuation of the motion-sensing controller upon being pressed and continuing upon release of the primary button. Methods and apparatus facilitating continual or momentary actuation of a motion-sensing controller using at least one primary button thereon comprise any suitable electrical or mechanical methodology and apparatus.

In one embodiment, at least one primary button is configured so that the motion-sensing controller remains continually actuated after the at least one primary button is pressed and continues upon the primary button's release (i.e., as in a push-push button where the button remains depressed after it is first pressed and released and until it is pressed and released another time, at which time the button returns to its original state).

In another embodiment, at least one primary button is configured so that the motion-sensing controller is momentarily actuated upon being partially pressed and continually actuated upon being fully pressed and continuing after release of the at least one primary button. In this embodiment, by pressing the primary button with less than full force (i.e., a partial press), the motion-sensing controller interprets the partial press as a command for momentary actuation for only the duration of the press as opposed to continual actuation beginning with the press and continuing upon release of the primary button. After being continually actuated, actuation is disabled by pressing and releasing the primary button. De-actuation can be accomplished using a partial press and release or full press and release of the primary button.

According to an alternative aspect of this embodiment, when the primary button is in an “on” position, the primary button is reset to the “off” condition at a desired time (e.g., after a play during a game or at the end of each game). Such automatic return to the “off” position can be accomplished using any suitable methodology and apparatus (e.g., through programming of the motion-sensing controller).

According to another embodiment, the motion-sensing controller comprises at least two primary buttons for actuation of the same function on the motion-sensing controller. Depending on the type of actuation desired, for example, the primary button providing that type of actuation can be employed.

In one embodiment, a first primary button is configured so that the motion-sensing controller is momentarily actuated while the first primary button is pressed and until the first primary button is thereafter released. According to this embodiment, a second primary button is configured so that the motion-sensing controller remains continually actuated when the second primary button is pressed and continuing after it is released. According to one aspect of this embodiment, when the second primary button is in an “on” position, with the motion-sensing controller continually actuated, the second primary button returns to an “off” position automatically when the first primary button is pressed. In this manner, the second primary button need not be turned to the “off” position before using the first primary button for momentary actuation of the motion-sensing controller. According to an alternative aspect of this embodiment, when the second primary button is in an “on” position, the second primary button is reset to the “off” condition at a desired time (e.g., after a play during a game or at the end of each game). Such automatic return to the “off” position can be accomplished using any suitable methodology and apparatus (e.g., through programming of the motion-sensing controller).

Each of the optional auxiliary buttons is located on any suitable part of the base and comprises any suitable shape and configuration for, as an example, controlling video game functions and game play. A number of auxiliary buttons and their configuration are known to those of ordinary skill in the art. For example, a conventional “Wii Remote” motion-sensing video game controller marketed by Nintendo Corporation, Ltd. has seven such auxiliary buttons. Those seven auxiliary buttons are the power button, the (+) control pad, the minus (−) button, the plus (+) button, the home button, the one (1) button, and the two (2) button.

Each of the base, the at least one primary button, and the optional at least one auxiliary button comprises any suitable material such as, for example, a durable plastic material. In a further embodiment, at least one of the base, the at least one primary button, and the optional at least one auxiliary button comprises a relatively soft outwardly exposed material, which can help to minimize injury from accidents involving the controller.

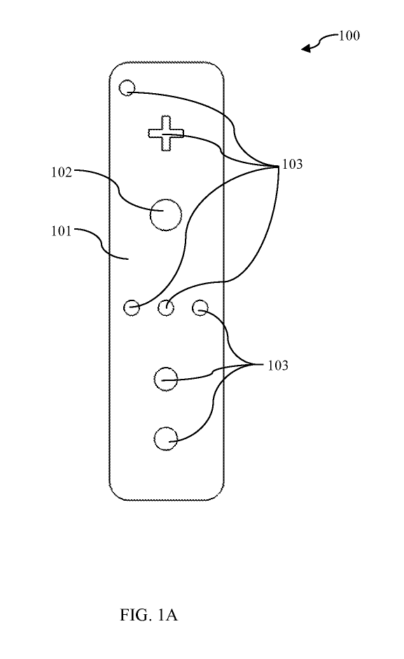

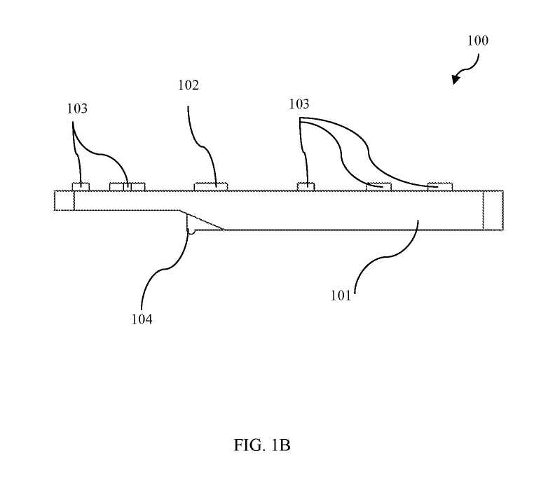

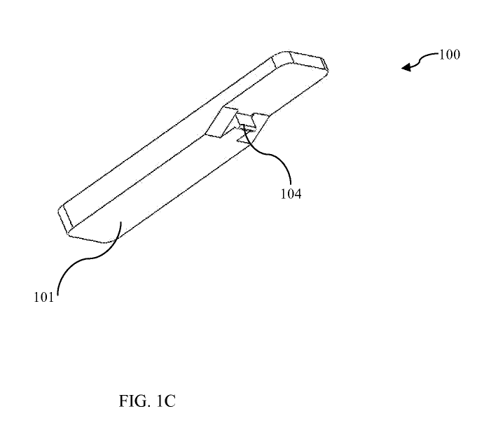

As illustrated in FIGS. 1A-1C, an exemplary motion-sensing controller 100 comprises a base 101, a primary button 102, and seven auxiliary buttons 103. In this embodiment, the primary button 102 comprises a circular tab protruding from a top surface of the base 101. In one embodiment, the primary button 102 is configured to continually actuate the motion-sensing controller 100 upon being pressed and continuing after the primary button 102 is released. In a further embodiment, the primary button 102 is configured to momentarily actuate the motion-sensing controller 100 upon a partial press of the primary button 102 and continually actuate the motion-sensing controller 100 after a full press and release of the primary button 102.

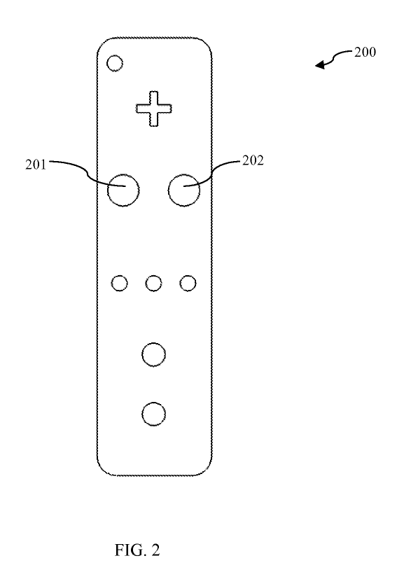

As illustrated in FIG. 2, another embodiment of a motion-sensing controller 200 comprises a similar configuration as that illustrated in FIGS. 1A-1C, except with respect to the number of primary buttons 201, 202. According to this embodiment, the motion-sensing controller 200 comprises two primary buttons 201, 202 protruding from a top surface of the base. Function of the two primary buttons 201, 202 is interpreted as the same command by the motion-sensing controller 200. In one embodiment, one or both of the two primary buttons 201, 202 is configured so that the motion-sensing controller 200 interprets pressing of the respective primary button 201, 202 as a command for continual actuation that continues after release of that primary button 201, 202. In another embodiment, one or both of the primary buttons 201, 202 is configured so that the motion-sensing controller 200 interprets pressing of the respective primary button 201, 202 as a command for momentary actuation while the respective primary button 201, 202 is being pressed.

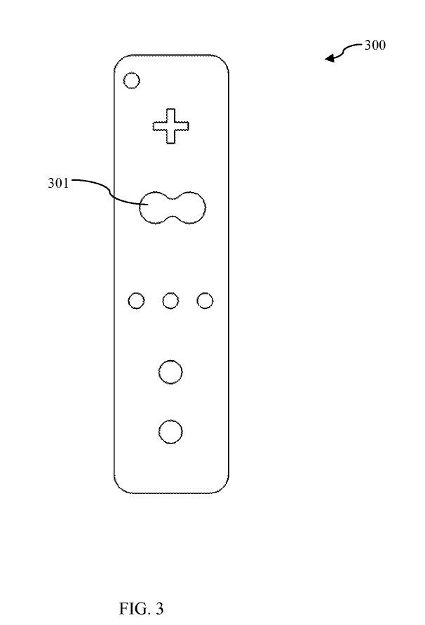

As illustrated in FIG. 3, another embodiment of a motion-sensing controller 300 comprises a similar configuration as those illustrated in FIGS. 1A-1C and 2, except with respect to the shape of the primary button 301. According to this embodiment, the motion-sensing controller 300 comprises one primary button 301 protruding from a top surface of the base. The primary button 301 is shaped as two connected round buttons and resembles a switch. A press on one side of the primary button 301 is interpreted by the motion-sensing controller 300 as a command for continual actuation of the motion-sensing controller 300 that continues after the press is released. According to one aspect of this embodiment, a press and release on the other side of the primary button 301 is interpreted by the motion-sensing controller 300 as a command to disable actuation of (i.e., de-actuate) the motion-sensing controller 300. According to another aspect of this embodiment, a press on the other side of the primary button 301 is interpreted by the motion-sensing controller 300 as a command for momentary actuation of the motion-sensing controller 300 while that side of the primary button 301 is being pressed.

Various apparatus of the invention can be employed to provide more realistic holding of a motion-sensing controller during, for example, game play. Such apparatus can be used with any suitable motion-sensing controller, including those of the invention described above. In certain embodiments, apparatus of the invention facilitate continual actuation of the motion-sensing controller (e.g., using at least one primary and/or retainer button on the controller) when necessary or desired.

In one embodiment, apparatus of the invention are attached to an actual or simulated piece of equipment or portion thereof at a location proximate where one would ordinarily grip the piece of equipment. In another embodiment, which is generally preferred, a player is able to hold an assembly shaped like an object displayed in a video game at a position on the assembly where one would normally grip the same as opposed to requiring that the assembly be held at the location of a motion-sensing controller housed therein.

One embodiment of a motion-sensing controller apparatus of the invention comprises: a case for insertion of the motion-sensing controller therein; at least one retainer capable of securing the motion-sensing controller in the case, wherein the motion-sensing controller is secured between the at least one retainer and the case when the motion-sensing controller is inserted in the case; at least one retainer button coupled to the at least one retainer for mechanically facilitating continual and/or momentary actuation of the motion-sensing controller; optionally, at least one connector mechanically coupled to the case for attaching the case to at least one piece of simulated sports, recreation, or other similar equipment, or portion thereof; and, optionally, at least one retaining clip mechanically coupled to the case for attaching the apparatus to at least one piece of actual sports, recreation, or other similar equipment.

In another embodiment, a motion-sensing controller apparatus of the invention comprises: a case for insertion of the motion-sensing controller therein; at least one retainer capable of securing the motion-sensing controller in the case; at least one retainer button coupled to the at least one retainer for mechanically facilitating continual actuation of the motion-sensing controller; optionally, at least one connector mechanically coupled to the case for attaching the case to at least one piece of simulated sports, recreation, or other similar equipment, or portion thereof; and, optionally, at least one retaining clip mechanically coupled to the case for attaching the apparatus to at least one piece of actual sports, recreation, or other similar equipment.

In another embodiment, a motion-sensing controller apparatus of the invention comprises: a case for insertion of the motion-sensing controller therein; at least one retainer capable of securing the motion-sensing controller in the case; at least one retainer button coupled to the at least one retainer for mechanically facilitating continual and/or momentary actuation of the motion-sensing controller; at least one connector mechanically coupled to the case for attaching the case to at least one piece of simulated sports, recreation, or other similar equipment selected from a golf club, a tennis racket, a baseball bat, a hockey stick, a cricket bat, a sword, a knife, a fishing pole, a ping pong paddle, a pool cue, a racquetball racket, and a badminton racket, or portion thereof; and, optionally, at least one retaining clip mechanically coupled to the case for attaching the apparatus to at least one piece of actual sport, recreation, or other similar equipment.

In another embodiment, a motion-sensing controller apparatus of the invention comprises: a case for insertion of the motion-sensing controller therein; at least one retainer capable of securing the motion-sensing controller in the case; optionally, at least one retainer button coupled to the at least one retainer for mechanically facilitating continual and/or momentary actuation of the motion-sensing controller; at least one connector mechanically coupled to the case for attaching the case to a handle comprising a gripping portion of at least one piece of simulated sports, recreation, or other similar equipment; and, optionally, at least one retaining clip mechanically coupled to the case for attaching the apparatus to at least one piece of actual sport, recreation, or other similar equipment.

In another embodiment, a motion-sensing controller apparatus of the invention comprises: a case for insertion of the motion-sensing controller therein; at least one retainer capable of securing the motion-sensing controller in the case; optionally, at least one retainer button coupled to the at least one retainer for mechanically facilitating continual and/or momentary actuation of the motion-sensing controller; optionally, at least one connector mechanically coupled to the case for attaching the case to at least one piece of simulated sports, recreation, or other similar equipment, or portion thereof; and, at least one retaining clip mechanically coupled to the case for attaching the apparatus to at least one piece of actual sports, recreation, or other similar equipment.

In the various embodiments, each of the case, the retainer, the connector, and the retaining clip or multiples thereof may be formed as a single component or as discrete components. According to one embodiment, at least the case and the retainer portions of the apparatus are formed as discrete components, which are then mechanically coupled when forming the apparatus. The components may be formed using any suitable methodology. In an exemplary embodiment, each of the components is formed by molding the same.

Further, each of the motion-sensing controller, the case, the retainer, the retainer button, the connector, and the retaining clip or multiples thereof comprises any suitable material such as, for example, a durable plastic material. In a further embodiment, at least one of the controller, the case, the retainer, the retainer button, the connector, and the retaining clip or multiples thereof comprises a relatively soft outwardly exposed material, which can help to minimize injury from accidents involving the controller.

The case comprises any suitable shape and configuration for accepting and housing a motion-sensing controller. In one embodiment, the case comprises a rectangular open-ended box. This embodiment is particularly applicable for use with a “Wii Remote.”

Each retainer comprises any suitable shape and configuration for securing the motion-sensing controller within the case. For increased retention of the motion-sensing controller, preferably the retainer and the case are configured so that the motion-sensing controller is secured between the same when it is inserted in the case. In an exemplary embodiment, the retainer comprises a band or similar shape (e.g., a bar) that extends over a motion-sensing controller when it is inserted in the case. In one embodiment, at least one retainer comprises a bar-shaped retainer. The retainer can be permanently affixed to the case or removable therefrom. Preferably, the retainer is removable from the case to facilitate ease of inserting the motion-sensing controller in the case. In an exemplary embodiment, the retainer is capable of being removed from the apparatus by sliding the retainer along a slotted hole to remove the retainer from the case.

The case and retainer are also shaped and configured to facilitate operation of a motion-sensing controller housed in the case. In an exemplary embodiment, the case and retainer are designed so that buttons on the motion-sensing controller are capable of mechanically facilitating continual and/or momentary actuation of the motion-sensing controller. According to this embodiment, if a primary button necessary for adequate functioning of the motion-sensing controller is not directly accessible, a retainer button coupled to the retainer is configured to indirectly access the same according to further embodiments thereof.

When present, the retainer buttons are configured to electrically and/or mechanically (e.g., using a mechanical plunger) facilitate continual and/or momentary actuation of the motion-sensing controller. In an exemplary embodiment, at least one retainer button is configured to mechanically facilitate continual and/or momentary actuation of the motion-sensing controller (e.g., by mechanically pressing and releasing at least one primary button on the motion-sensing controller). In a further embodiment, the retainer button is configured to momentarily actuate the motion-sensing controller upon being partially pressed and continually actuate the motion-sensing controller upon being fully pressed and continuing upon release of the retainer button. For example, when using a “Wii Remote” to play golf, a retainer button that facilitates continual actuation is preferred. However, when using a “Wii Remote” to play baseball or tennis, continual actuation is not generally needed.

In general, suitable shapes and configurations for the retainer buttons include those associated with primary buttons on the motion-sensing controller, including improved motion-sensing controllers of the invention. For example, the retainer button comprises a circular tab protruding from a top surface of the retainer in one embodiment.

Advantageously, when present, the connector or multiples thereof facilitate attachment of interchangeable modules comprising at least a portion of simulated sports, recreation, or similar equipment to the apparatus. Such modules are preferably shaped like equipment involved in game play, e.g., sports, recreation, and similar equipment, or portions thereof, such equipment including, but not limited to, the following: golf clubs, tennis rackets, baseball bats, hockey sticks, cricket bats, swords, knives, fishing poles, ping pong paddles, pool cues, racquetball rackets, and badminton rackets.

In one embodiment, a module consisting essentially of a handle for a piece of equipment involved in game play is attached to a connector on one side of the case. In a preferred embodiment, a connector of associated apparatus is mechanically coupled to the case for attaching the case to a handle comprising a gripping portion of at least one piece of simulated sports, recreation, or other similar equipment. Exemplary handles comprising a gripping portion are shaft-based or tubular handles (e.g., handles of golf clubs, tennis rackets, baseball bats, hockey sticks, cricket bats, swords, knives, fishing poles, ping pong paddles, pool cues, racquetball rackets, and badminton rackets). As such, a player is able to hold an assembly shaped like an object displayed in a video game at a position on the assembly where one would normally grip the same as opposed to requiring that the assembly be held at the location of a motion-sensing controller therein.

According to a further embodiment, another module is attached to a connector on another side of the case (e.g., an opposite side from that to which the handle is attached). Such a module can be, for example, the remaining portion of the piece of equipment so that the assembly is similar in size and weight to an actual piece of equipment when coupled with a motion-sensing controller. Alternatively, the module can be a weight of any shape that provides an assembly feeling like the actual piece of equipment, but varying significantly in shape.

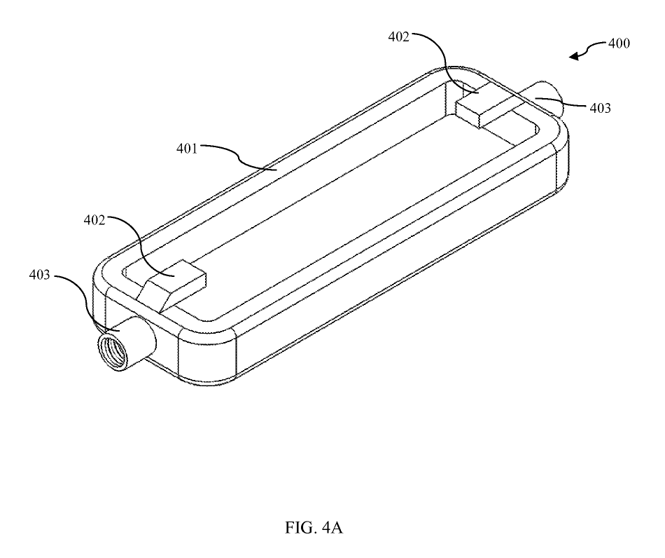

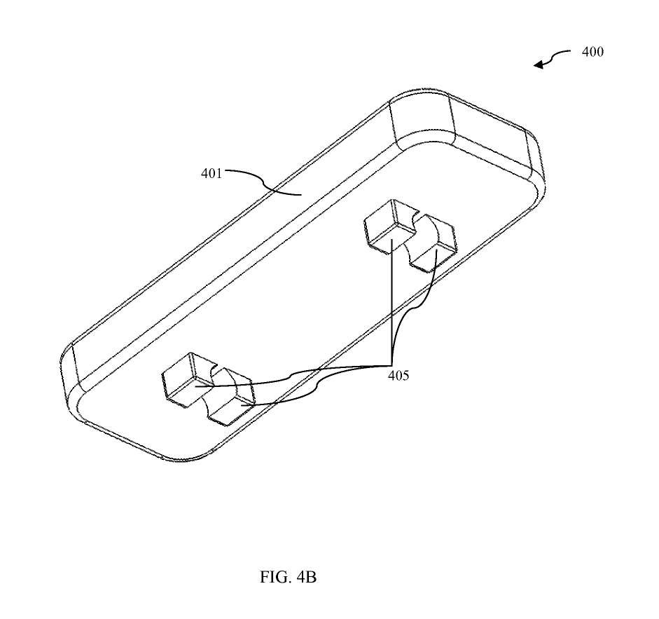

FIG. 4A is a top perspective view of one embodiment of an apparatus 400 for a motion-sensing controller according to the invention. The apparatus 400 comprises: a case 401 for insertion of a motion-sensing controller therein, a plurality of retainers 402 for retention of the motion-sensing controller within the case 401, and a plurality of connectors 403 outwardly coupled to opposing sides of the case 401 for optional attachment of the case 401 to at least one other piece of simulated equipment or portion thereof.

FIG. 4B is a bottom perspective view of another embodiment of an apparatus 400 for a motion-sensing controller according to the invention. As compared to the motion-sensing controller illustrated in FIG. 4A, the embodiment illustrated in FIG. 4B does not include connectors. Rather, as illustrated therein, the case 401 of FIG. 4B comprises a plurality of retaining clips 405 on an underside thereof.

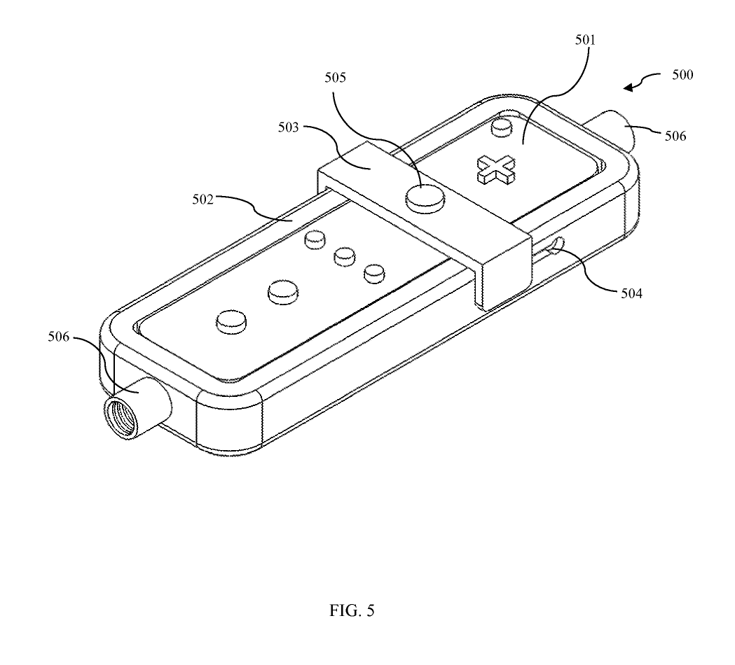

FIGS. 5, 6, and 7 illustrate top perspective views of various embodiments of apparatus for motion-sensing controllers according to the invention. In each of these illustrations, a motion-sensing controller is shown housed within the apparatus. With respect to the apparatus 500 of FIG. 5, a motion-sensing controller 501 is housed within a case 502. The motion-sensing controller 501 is secured within the case 502 by a bar-shaped retainer 503. The retainer 503 is capable of being removed from the apparatus 500 by sliding along a slotted hole 504.

The retainer 503 illustrated in FIG. 5 comprises a retainer button 505 coupled to a top surface of the retainer 503. The retainer button 505 comprises a circular tab protruding from a top surface of the retainer 503. In one embodiment, the retainer button 505 is configured to momentarily actuate the motion-sensing controller 501 upon being partially pressed and continually actuate the motion-sensing controller 501 upon being fully pressed and continuing upon release of the retainer button 505.

The case 502 illustrated in FIG. 5 comprises connectors 506 outwardly coupled to opposing sides of the case 502 for optional attachment of the case 502 to at least one other piece of simulated equipment or portion thereof. Each of the connectors 506 comprises any suitable shape and configuration for attaching the case 502 to at least one piece of simulated sports, recreation, or similar equipment or portion thereof, e.g. a golf club handle.

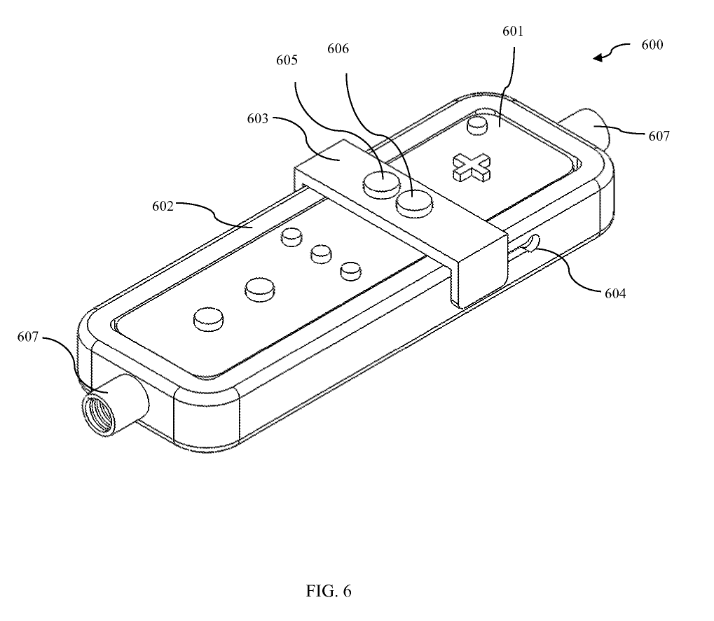

With respect to the apparatus 600 of FIG. 6, a motion-sensing controller 601 is also housed within the case 602. The motion-sensing controller 601 is secured within the case 602 by a bar-shaped retainer 603. The retainer 603 is capable of being removed from the apparatus 600 by sliding along a slotted hole 604. The retainer 603 illustrated in FIG. 6 comprises two retainer buttons 605, 606. The two retainer buttons 605, 606 have the same general shape and configuration as at least one primary button on motion-sensing controllers of the invention. Function of the two retainer buttons 605, 606 is interpreted as the same command by the motion-sensing controller 601.

In one embodiment, one or both of the two retainer buttons 605, 606 is configured so that the motion-sensing controller 601 interprets pressing of the respective retainer button 605, 606 as a command for continual actuation that continues upon release of that retainer button 605, 606. In another embodiment, one or both of the retainer buttons 605, 606 are configured so that the motion-sensing controller 601 interprets pressing of the respective retainer button 605, 606 as a command for momentary actuation. The case 602 comprises connectors 607 outwardly coupled to opposing sides of the case 602 for optional attachment of the case 602 to at least one other piece of simulated equipment or portion thereof. Each of the connectors 607 comprises any suitable shape and configuration for attaching the case 602 to at least one piece of simulated sports, recreation, or similar equipment or portion thereof, e.g. a golf club handle.

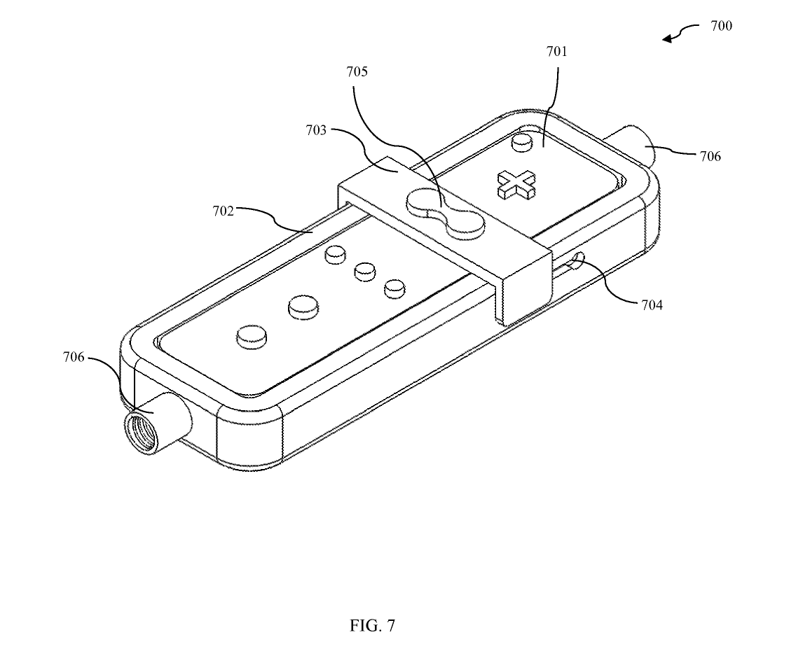

With respect to the apparatus 700 of FIG. 7, a motion-sensing controller 701 is also housed within the case 702. The motion-sensing controller 701 is secured within the case 702 by a bar-shaped retainer 703. The retainer 703 is capable of being removed from the apparatus 700 by sliding along a slotted hole 704. The retainer 703 illustrated in FIG. 7 comprises a retainer button 705 coupled to a top of surface of the retainer 703. The retainer button 705 is shaped as two connected round buttons and resembles a switch. A press on one side of the retainer button 705 is interpreted by the motion-sensing controller 701 as a command for continual actuation that continues upon release of that side of the retainer button 705. According to one aspect of this embodiment, a press and release on the other side of the retainer button 705 is interpreted by the motion-sensing controller 700 as a command to disable actuation (i.e., de-actuate) the motion-sensing controller 700. According to another aspect of this embodiment, a press on the other side of the retainer button 705 is interpreted by the motion-sensing controller 701 as a command for momentary actuation of the motion-sensing controller. The case 702 comprises connectors 706 outwardly coupled to opposing sides of the case 702 for optional attachment of the case 702 to at least one other piece of simulated equipment or portion thereof. Each of the connectors 706 comprises any suitable shape and configuration for attaching the case 702 to at least one piece of simulated sports, recreation, or similar equipment or portion thereof, e.g., a golf club handle.

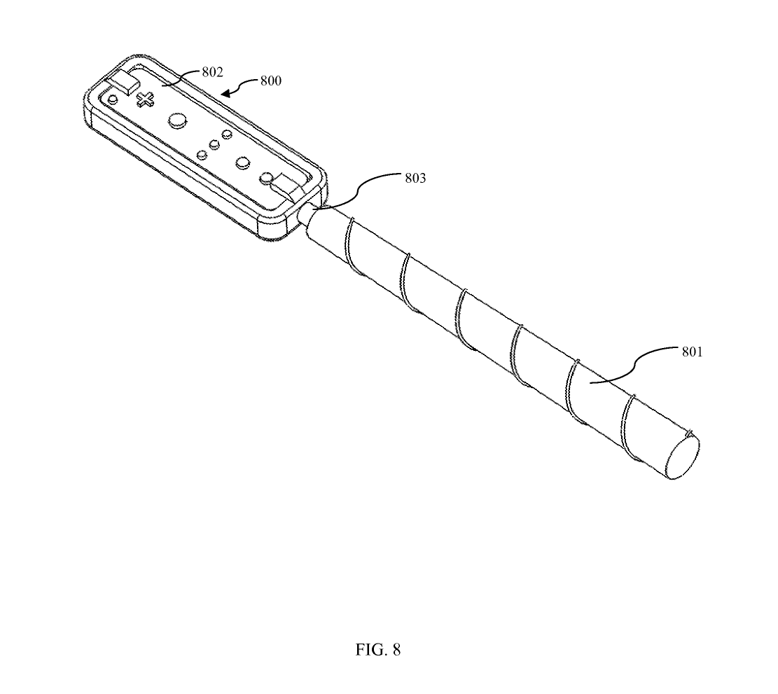

FIG. 8 is a top perspective view of the apparatus 800 detailed as apparatus 400 in FIG. 4A housing a motion-sensing controller therein and attached to an exemplary handle 801 for use with a motion-sensing controller 802. The handle 801 illustrated in FIG. 8 resembles the handle of a conventional golf club and is coupled to the apparatus 800 via a connector 803. In an exemplary embodiment, the handle 801 comprises a threaded rod on one end that is capable of mating to threads (not illustrated) of the connector 803. The handle 801 and attached apparatus 800 may be formed as a single component or as discrete components. According to one embodiment, the handle 801 and the attached apparatus 800 are formed as discrete components, which are then mechanically coupled.

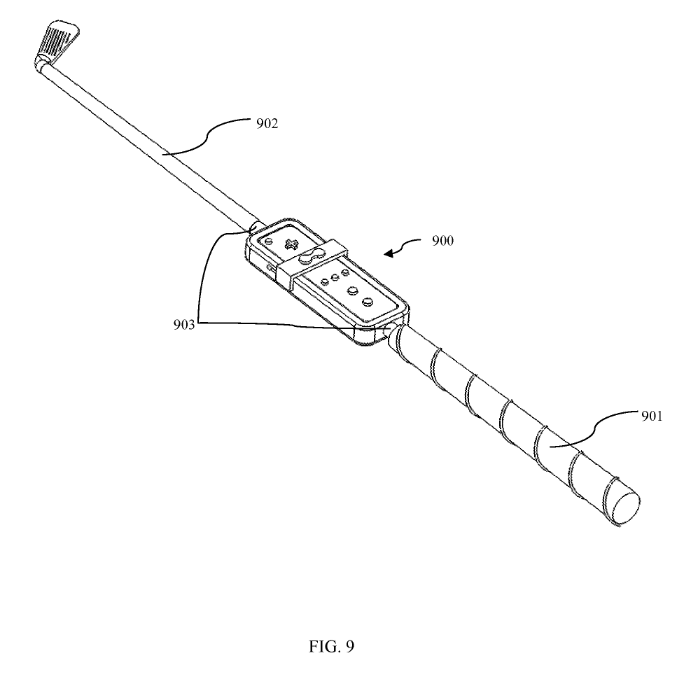

FIG. 9 is a top perspective view of the apparatus 900 detailed as apparatus 700 in FIG. 7 housing a motion-sensing controller therein and attached to an exemplary handle 901 and an exemplary golf club head 902 according to the invention. Both the handle 901 and the golf club head 902 are capable of being mated to connectors 903 on the apparatus 900 to provide an entire assembly resembling a conventional golf club. The handle 901 and attached apparatus 900 may be formed as a single component or as discrete components. According to one embodiment, the handle 901 and the attached apparatus 900 are formed as discrete components, which are then mechanically coupled to form the golf club assembly.

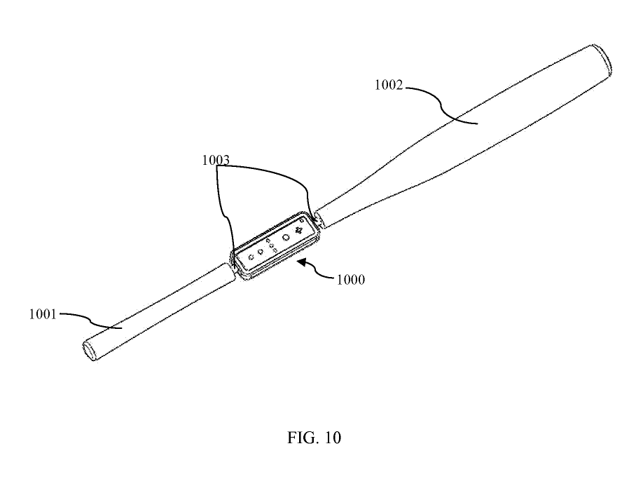

Similarly, FIG. 10 is a top perspective view of an apparatus 1000 housing a motion-sensing controller therein and attached to an exemplary handle 1001 and an exemplary portion of a baseball bat 1002 according to the invention. Both the handle 1001 and the illustrated portion of a baseball bat 1002 are capable of being mated to connectors 1003 on the apparatus 1000 to provide an entire assembly resembling a conventional baseball bat. The handle 1001 and attached apparatus 1000 may be formed as a single component or as discrete components. According to one embodiment, the handle 1001 and the attached apparatus 1000 are formed as discrete components, which are then mechanically coupled to form the baseball bat assembly.

Similarly, FIG. 11 is a top perspective view of an apparatus 1100 housing a motion-sensing controller therein and attached to an exemplary handle 1101 and an exemplary portion of a racket 1102 (e.g., tennis racket) according to the invention. Both the handle 1101 and the illustrated portion of a racket 1102 are capable of being mated to connectors 1103 on the apparatus 1100 to provide an entire assembly resembling a conventional racket. The handle 1101 and attached apparatus 1100 may be formed as a single component or as discrete components. According to one embodiment, the handle 1101 and the attached apparatus 1100 are formed as discrete components, which are then mechanically coupled to form the racket assembly.

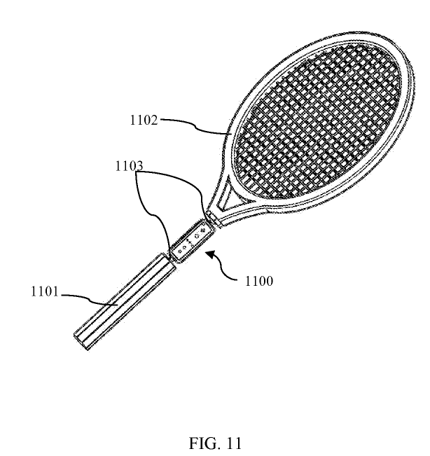

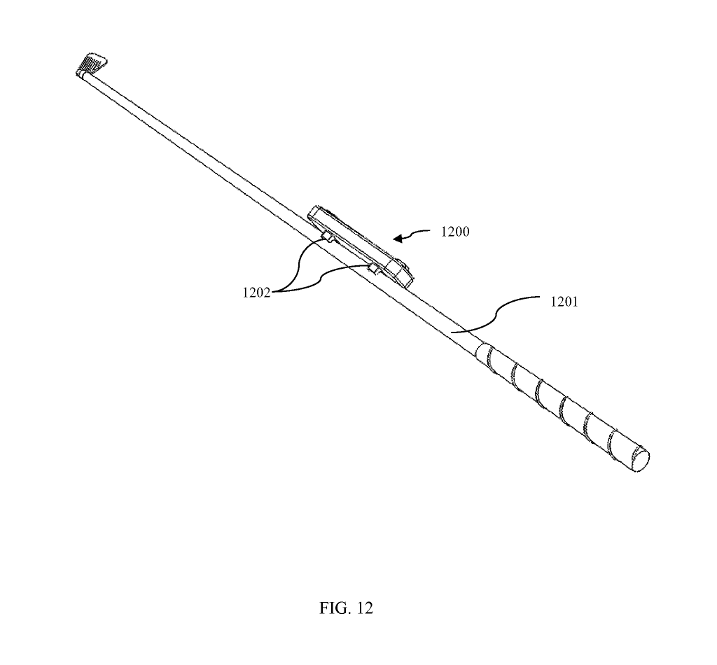

When present, the retaining clip or multiples thereof in apparatus of the invention facilitate secure attachment of actual sports, recreation, or similar equipment to the apparatus. For example, FIG. 12 is a perspective view of an apparatus 1200 of the invention housing a motion-sensing controller therein and attached to an exemplary golf club 1201 according to the invention. Attachment of the golf club 1201 is accomplished using any suitable method and apparatus. For example, a plurality of retaining clips 1202 on the apparatus 1200 is capable of being securely coupled to a shaft portion of the golf club 1201.

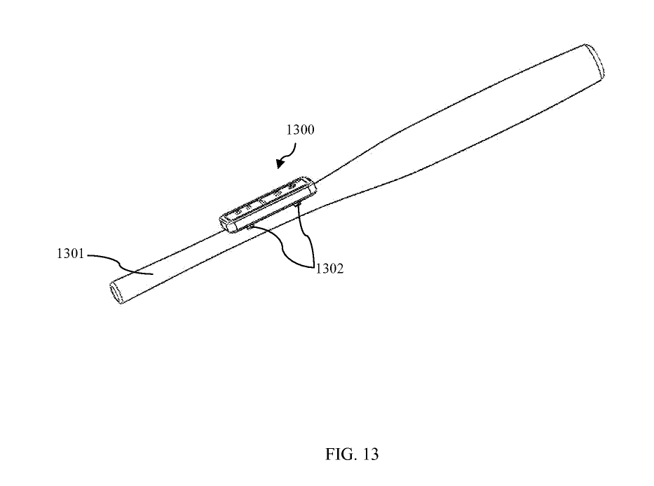

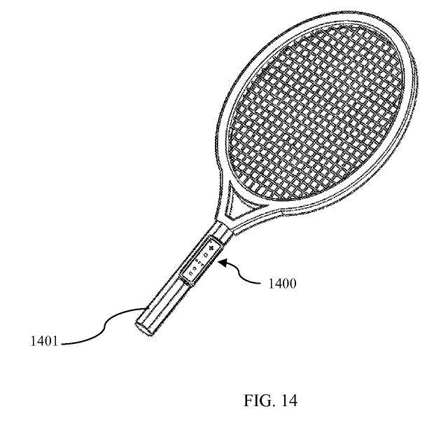

As another example, FIG. 13 is a perspective view of an apparatus 1300 of the invention housing a motion-sensing controller therein and attached to an exemplary baseball bat 1301 according to the invention. Attachment of the baseball bat 1301 is accomplished using a plurality of retaining clips 1302 on the apparatus 1300. As yet another example, FIG. 14 is a perspective view of an apparatus 1400 of the invention housing a motion-sensing controller therein and attached to an exemplary racket 1401 (e.g., tennis racket) according to the invention.

The number, shape, and configuration of the optional retaining clips vary depending on the type of equipment to be attached to the apparatus. When the apparatus is attached to at least one piece of sports, recreation, or similar equipment, one or more retaining clips is positioned on each side of the piece of sports, recreation, or similar equipment. The number of retaining clips need not be the same on each side of the piece of equipment. The same applies to the shape and configuration of the retaining clips.

In one embodiment, one or more retaining clips comprise an inwardly rounded, open-ended block for attaching the apparatus to a cylindrical shaft of a conventional golf club (e.g., retaining clips 405 illustrated in FIG. 4B, which retaining clips 1202 facilitate attachment of the apparatus 1200 to a golf club 1201 as illustrated in FIG. 12).

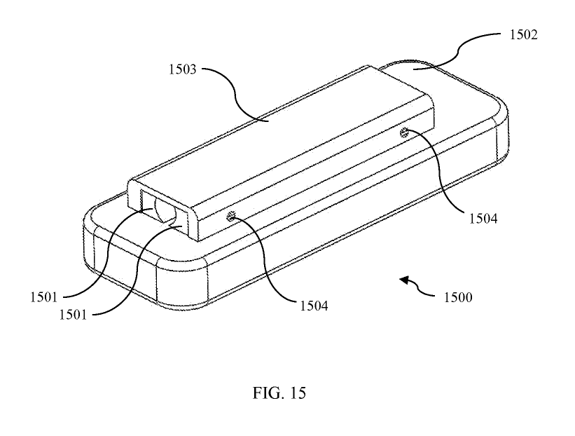

In another embodiment, as illustrated in FIG. 15, an apparatus 1500 also comprises retaining clips 1501 shaped as inwardly rounded, open-ended blocks coupled to a bottom side of a case 1502 on a side opposite from that in which a motion-sensing controller is inserted therein. In order to secure a piece of equipment between the retaining clips 1501, a retaining plate 1502 is secured over a portion of the equipment and fastened to the retaining clips 1501 using one or more screws 1503. Underneath the retaining plate 1502, each of the retaining clips 1501 may be segmented into two or more retaining clips along its length. Further, the retaining plate 1502 itself may be segmented into two or more portions along its length, each portion being secured over a portion of the equipment and fastened to the retaining clips 1501 using one or more screws 1503.

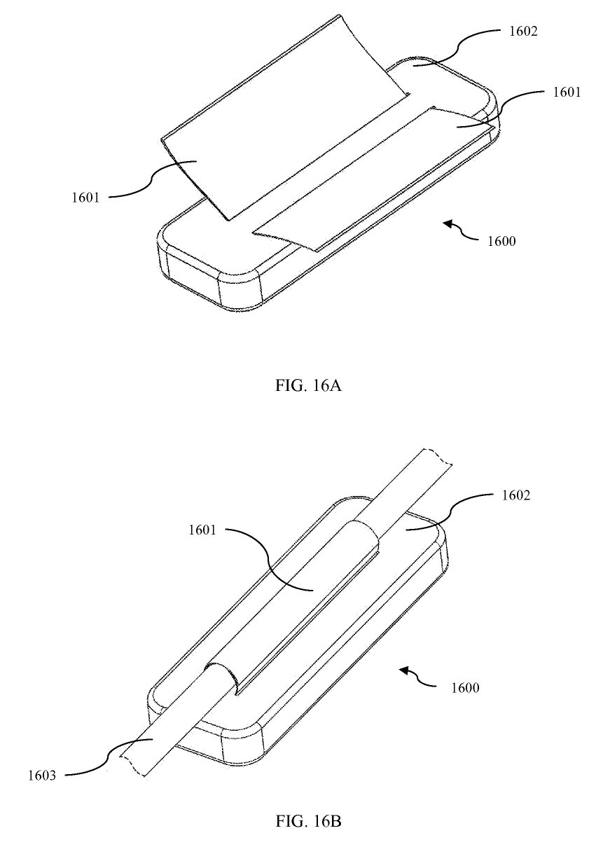

In another embodiment, as illustrated in FIGS. 16A and 16B, an apparatus 1600 comprises a retaining clip 1601 shaped as a flexible wrap coupled to a bottom side of a case 1602 on a side opposite from that in which a motion-sensing controller is inserted therein. In order to secure a piece of equipment 1603 within the retaining clip 1601, the retaining clip 1601 is capable of being securely wrapped around the piece of equipment 1603. According to one aspect of this embodiment, the retaining clip 1601 comprises soft cloth with ends that can be wrapped over each other and secured using any suitable mechanism. In one embodiment, hook-and-loop fasteners are used to secure the flexible wrap together. However, other fastening mechanisms, such as zippers, strings, locking pins, and the like can also be used. In an exemplary embodiment, one contiguous sheet of cloth is used for the retaining clip 1601, with the sheet going through and pulling back out of the case 1602. In an alternative embodiment, two sheets of cloth can be used for the retaining clip 1601, with each sheet being mechanically coupled to the case 1602.

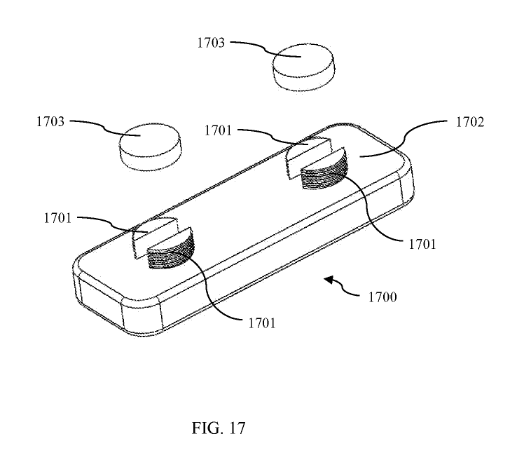

In another embodiment, as illustrated in FIG. 17, an apparatus 1700 comprises retaining clips 1701 with outwardly threaded surfaces coupled to a bottom side of a case 1702 on a side opposite from that in which a motion-sensing controller is inserted therein. In order to secure a piece of equipment between the retaining clips 1701, inwardly threaded screw caps 1703 are fastened over the retaining clips 1701 after the piece of equipment is inserted therebetween.

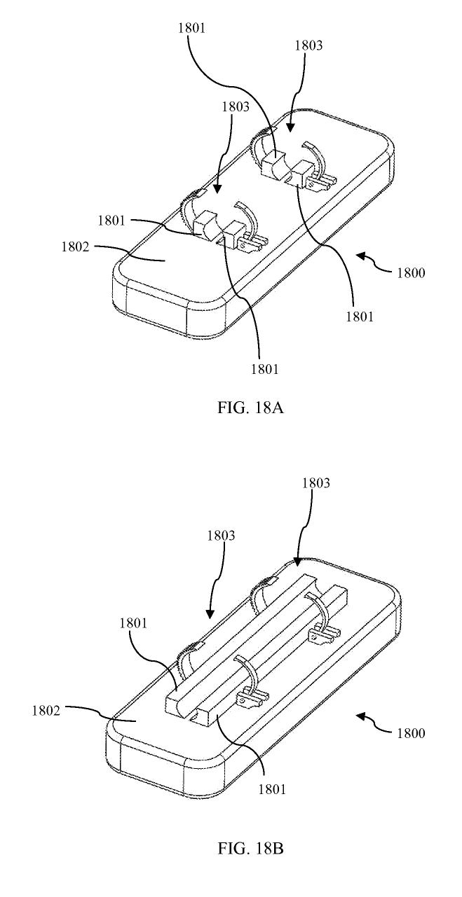

In yet another embodiment, as illustrated in FIGS. 18A and 18B, an apparatus 1800 comprises retaining clips 1801 shaped as inwardly rounded, open-ended blocks coupled to a bottom side of a case 1802 on a side opposite from that in which a motion-sensing controller is inserted therein. In order to secure a piece of equipment between the retaining clips 1801, one or more locking clips 1803 (e.g., the type of clip used for box locking or ski boot locking) is secured over a portion of the equipment. Underneath the locking clips 1803, each of the retaining clips 1801 may be segmented into two or more retaining clips along its length, such as that embodiment illustrated in FIG. 18A. Alternatively, each of the retaining clips 1801 may be continuous along its length, such as that embodiment illustrated in FIG. 18B.

The retaining clips are formed of any suitable material. In exemplary embodiment, a portion of the retaining clip in contact with a piece of equipment secured to the apparatus therewith comprises a material that facilitates gripping of the equipment. Such materials include, for example, rubber, soft cloth, soft plastic, soft foam, and the like, all of which can be coated on the retaining clip or attached to/inserted within the retaining clip.

Various modifications and alterations of the invention will become apparent to those skilled in the art without departing from the spirit and scope of the invention, which is defined by the accompanying claims. The invention is not limited to motion-sensing video game controllers, but also applies to related or equivalent motion-sensing equipment (e.g., any piece of equipment comprising a motion-sensing device, such as an accelerometer or optical sensor, therein). It should be noted that the motion-sensing controllers and apparatus of the invention can include any suitable materials, lighting apparatus, flashing apparatus, circuitry, and the like and can be of any suitable color, taste, smell, shape, and design. Variability to accommodate players of different ages, genders, and sizes, for example, is within the scope of the invention. It should also be noted that steps recited in any method claims below do not necessarily need to be performed in the order that they are recited. Those of ordinary skill in the art will recognize variations in performing the steps from the order in which they are recited. In addition, the lack of mention or discussion of a feature, step, or component provides the basis for claims where the absent feature or component is excluded by way of a proviso or similar claim language. Further, it is to be understood that a button need not always be released after a press for de-actuation or momentary actuation of the motion-sensing controller to occur.

What is claimed is:

1. A motion-sensing controller comprising:
a base that allows the motion-sensing controller to transmit any necessary signals remotely;
at least one primary button configured for continual actuation of the motion-sensing controller when pressed and continuing after the primary button is released; and
optionally, at least one auxiliary button.

2. The controller of claim 1, wherein the at least one primary button is configured to momentarily actuate the motion-sensing controller when partially pressed and continually actuate the motion-sensing controller when fully pressed and continuing upon release of the primary button.

3. The controller of claim 1, wherein the at least one primary button functions to continually actuate the motion-sensing controller when a first side of the primary button is pressed and continuing upon release of that first side of the primary button.

4. The controller of claim 3, wherein the at least one primary button is configured to de-actuate the motion-sensing controller when a second side of the primary button is pressed and released.

5. The controller of claim 3, wherein the at least one primary button is configured to momentarily actuate the motion-sensing controller when a second side of the primary button is pressed.

6. The controller of claim 1 comprising at least two primary buttons.

7. The controller of claim 1, wherein the motion-sensing controller comprises a motion-sensing video game controller.

8. A motion-sensing controller apparatus comprising:
a case for insertion of the motion-sensing controller therein;
at least one retainer capable of securing the motion-sensing controller in the case, wherein the motion-sensing controller is secured between the at least one retainer and the case when the motion-sensing controller is inserted in the case;
at least one retainer button coupled to the at least one retainer for mechanically facilitating continual and/or momentary actuation of the motion-sensing controller;
optionally, at least one connector mechanically coupled to the case for attaching the case to at least one piece of simulated sports, recreation, or other similar equipment, or portion thereof; and
optionally, at least one retaining clip mechanically coupled to the case for attaching the apparatus to at least one piece of actual sports, recreation, or other similar equipment.

9. The apparatus of claim 8, wherein the at least one retainer is removably coupled to the case.

10. An assembly comprising the apparatus of claim 8 attached to at least one piece of actual or simulated sports, recreation, other similar equipment, or portion thereof.

11. The assembly of claim 10, wherein the apparatus is attached to a golf club, a tennis racket, a baseball bat, or a portion thereof.

12. A motion-sensing controller apparatus comprising:
a case for insertion of the motion-sensing controller therein;
at least one retainer capable of securing the motion-sensing controller in the case;
at least one retainer button coupled to the at least one retainer for mechanically facilitating continual actuation of the motion-sensing controller;
optionally, at least one connector mechanically coupled to the case for attaching the case to at least one piece of simulated sports, recreation, or other similar equipment, or portion thereof; and
optionally, at least one retaining clip mechanically coupled to the case for attaching the apparatus to at least one piece of actual sports, recreation, or other similar equipment.

13. The apparatus of claim 12, wherein the at least one retainer is removably coupled to the case.

14. An assembly comprising the apparatus of claim 12 attached to at least one piece of actual or simulated sports, recreation, other similar equipment, or portion thereof.

15. The assembly of claim 14, wherein the apparatus is attached to a golf club, a tennis racket, a baseball bat, or a portion thereof.

16. A motion-sensing controller apparatus comprising:
a case for insertion of the motion-sensing controller therein;
at least one retainer capable of securing the motion-sensing controller in the case;
optionally, at least one retainer button coupled to the at least one retainer for mechanically facilitating continual and/or momentary actuation of the motion-sensing controller;
at least one connector mechanically coupled to the case for attaching the case to a handle comprising a gripping portion of at least one piece of simulated sports, recreation, or other similar equipment; and
optionally, at least one retaining clip mechanically coupled to the case for attaching the apparatus to at least one piece of actual sport, recreation, or other similar equipment.

17. The apparatus of claim 16, wherein the at least one retainer is removably coupled to the case.

18. An assembly comprising the apparatus of claim 16 attached to at least one piece of actual or simulated sports, recreation, other similar equipment, or portion thereof.

19. The assembly of claim 18, wherein the apparatus is attached to a golf club, a tennis racket, a baseball bat, or a portion thereof.

20. A motion-sensing controller apparatus comprising:
a case for insertion of the motion-sensing controller therein;
at least one retainer capable of securing the motion-sensing controller in the case;
optionally, at least one retainer button coupled to the at least one retainer for mechanically facilitating continual and/or momentary actuation of the motion-sensing controller;
optionally, at least one connector mechanically coupled to the case for attaching the case to at least one piece of simulated sports, recreation, or other similar equipment, or portion thereof; and
at least one retaining clip mechanically coupled to the case for attaching the apparatus to at least one piece of actual sports, recreation, or other similar equipment.

21. The apparatus of claim 20, wherein the at least one retainer is removably coupled to the case.

22. An assembly comprising the apparatus of claim 20 attached to at least one piece of actual or simulated sports, recreation, other similar equipment, or portion thereof.

23. The assembly of claim 22, wherein the apparatus is attached to a golf club, a tennis racket, a baseball bat, or a portion thereof.

24. A method for video game play with a motion-sensing video game controller comprising:
providing the motion-sensing controller of claim 1, wherein the motion-sensing controller is a motion-sensing video game controller; and
continually actuating the motion-sensing video game controller.

25. A method for video game play with a motion-sensing video game controller comprising:
providing the assembly of claim 10, wherein the assembly comprises a motion-sensing video game controller; and
using the at least one retainer button to continually actuate the motion-sensing video game controller.

26. A method for video game play with a motion-sensing video game controller comprising:
providing the assembly of claim 14, wherein the motion-sensing controller is a motion-sensing video game controller; and
using the at least one retainer button to continually actuate the motion-sensing video game controller.
